(19) United States
(12) Patent Application Publication
(10) Pub. No.: US 2026/0340880 A1
(43) Pub. Date: Oct. 29, 2026

(54) POINT CLOUD COMPRESSION SYSTEM AND METHOD FOR STREAMING

(71) Applicant: KOREA ELECTRONICS TECHNOLOGY INSTITUTE, Seongnam-si (KR)

(72) Inventors: Woo Chool PARK, Incheon (KR); Jun-Hwan JANG, Goyang-si (KR); Jin Wook YANG, Uijeongbu-si (KR); Minsu CHOI, Seoul (KR); Junsuk LEE, Seoul (KR); Bonjae KOO, Suwon-si (KR)

(73) Assignee: KOREA ELECTRONICS TECHNOLOGY INSTITUTE, Seongnam-si (KR)

(21) Appl. No.: 19/106,165

(22) PCT Filed: Dec. 5, 2022
(86) PCT No.: PCT/KR2022/019640

§ 371 Date: Feb. 24, 2025

(30) Foreign Application Priority Data
Aug. 22, 2022 (KR) 10-2022-0104796

(51) Int. Cl. G06T 9/00; G06T 9/40

(52) U.S. Cl. CPC G06T 9/001; G06T 9/40

(57) ABSTRACT

Disclosed in the present technology are a point cloud compression system and method for streaming. According to a specific example of the present technology, a spherical point cloud is converted to hexahedral points, then converted to tree structure points, each converted point of the tree structure is set as a reference point, and a normal vector of a point, in which an operation distance between each point of a child node of the set corresponding reference point and the corresponding reference point is less than or equal to the reference distance, is derived, such that calculation complexity and calculation speed according to the normal vector calculation can be reduced, and as encoding is performed for a point in which the inner value of the derived normal vector of the point and a user viewing direction vector obtained through a camera is a positive number, the amount of data to be encoded can be reduced, and communication resources and memory resources can be secured accordingly.

### TECHNICAL FIELD

The disclosure relates to a point cloud compression system and method for streaming, and more particularly, to a technique for encoding points where an inner product of a normal vector generated from a spherical image of a produced content and a direction vector of a user's field of view acquired by a camera is positive.

### BACKGROUND ART

Recently, with the demand for virtual reality (VR) contents, the demand for real-time services of VR contents is increasing.

VR contents need to be rendered in a spherical format, but there is a problem that conversion and transmission of spherical images are not appropriate to existing image conversion formats or broadcast transmission formats.

To solve this, a technique for reconstructing a spherical image into a rectangular plane by applying the Mercator projection (cylindrical projection) which is one of map projection methods was developed. However, this technique has a problem that a communication delay occurs in transmitting image data in the process of converting into a plane

Therefore, the applicant of the present application proposes a method that converts a spherical point cloud of a produced content into a hexahedron and converts points into points of a tree structure, derives a normal vector of points where a computational distance between a reference point of a first node in the converted tree structure and a point of a child node below a second node which is a subordinate node of the first node is less than or equal to a reference distance, and encodes points where an inner product value of the derived normal vector of the points and a direction vector of user's field of view obtained through a camera is positive, so that the amount of data to be encoded may be reduced and communication resources are fundamentally secured accordingly.

### PRIOR ART LITERATURE

### Patent Literature

Korean Patent Registration No. 10-1820359 (registered on Jan. 15, 2018)

### DISCLOSURE

### Technical Problem

The disclosure aims at reducing the amount of data to be encoded, reducing computational complexity caused by computation of a normal vector, and computational speed, and fundamentally securing communication resources.

The objects of the disclosure are not limited to those mentioned above, and other objects and advantages of the disclosure that are not mentioned above may be understood from the descriptions presented below, and will be more clearly understood from embodiments of the disclosure. It will also be readily apparent that the objects and advantages of the disclosure may be realized by the means set forth in the claims and combinations thereof.

### Technical Solution

According to an embodiment of the disclosure to achieve the above-described object, a point cloud compression system for streaming may include:
a point structuring device configured to convert a spherical point cloud of a produced content into points of a hexahedron, and then to convert the points into points in a tree structure;
a point normal vector estimation device configured to derive a normal vector of each point based on a defined reference distance and a computational distance between each point of the tree structure and each point of a child node of each point, and to store the derived normal vector of the corresponding point in a temporary memory; and
an encoding device configured to extract points to be encoded based on an inner product value of the normal vector of each point and a direction vector of a user's field of view acquired by a camera, and to encode and transmit the extracted points.

Preferably, the point normal vector estimation device may include:
a point alignment unit configured to set each point of the tree structure as a reference point, to output a computational distance between the set reference point and a point of a child node of each set reference point, to store reference points where the outputted computational distance is less than or equal to a pre-defined reference distance in a temporary memory, and to align the reference points stored in the temporary memory in an ascending order of the computational distance; and
a normal vector derivation unit configured to extract two adjacent points in the order of the computational distance from the reference point, to derive a normal vector of a plane that is formed with the extracted two adjacent points and the reference point, and to store the derived normal vector in a position of the temporary memory where the reference point is arranged.

Preferably, the point normal vector estimation device may include
a normal vector optimization unit configured to extract at least three points having a short computational distance from the reference point stored in the temporary memory, to average the normal vectors of the extracted points, and then to set the average normal vector as a normal vector of the reference point.

Preferably, the encoding device is configured to
derive an inner product value of the direction vector of the user's field of view acquired through the camera and the normal vector of each point, and to encode and transmit a point where the derived inner product value is positive.

According to another embodiment, a point cloud compression method for streaming may include:
a point structuring step of converting a spherical point cloud of a produced content into points of a hexahedron, and then converting the points into points in a tree structure;
a point normal vector estimation step of deriving a normal vector of each point based on a defined reference distance and a computational distance between each point of the tree structure and a point of a child node of each point, and storing the derived normal vector of the corresponding point in a temporary memory; and
an encoding step of extracting points to be encoded based on an inner product value of the normal vector of each point and a direction vector of a user's field of view acquired by a camera, and encoding and transmitting the extracted points.

Preferably, the point normal vector estimation step may include:
a step of setting each point of the tree structure as a reference point, and outputting a computational distance between the set corresponding reference point and each point of the child node;
a step of storing reference points where the outputted computational distance is less than or equal to a pre-defined reference distance in the temporary memory, and aligning the points stored in the temporary memory in an ascending order of the computational distance; and
a step of extracting two adjacent points in the order of the computational distance from the reference point, deriving a normal vector of a plane that is formed with the extracted two adjacent points and the reference point, and storing the derived normal vector in a position of the temporary memory where the reference point is arranged.

Preferably, the point normal vector estimation step may include
extracting at least three points having a short computational distance from the reference point stored in the temporary memory, averaging the normal vectors of the extracted points, and then setting the average normal vector as a normal vector of the reference point.

Preferably, the encoding step may be provided to
derive an inner product value of the direction vector of the user's field of view acquired through the camera and the normal vector of each point, and to encode and transmit a point where the derived inner product value is positive.

### Advantageous Effects

According to an embodiment, a spherical point cloud is converted into points of a hexahedron and then is converted into points of a tree structure, and each point of the converted tree structure is set as a reference point and a normal vector of points where a computational distance between each point of a child node of the set corresponding reference point and the corresponding reference point is less than or equal to a reference distance is derived, so that computational complexity caused by calculation of the normal vector and computational speed may be reduced.

According to the disclosure, encoding is performed for a point where an inner product value of the derived normal vector of the point and a direction vector of user's field of view obtained through a camera is positive, so that the amount of data to be encoded may be reduced and communication resources and memory resources may be secured accordingly.

### DESCRIPTION OF DRAWINGS

The following drawings, which accompany the specification, illustrate preferred embodiments of the disclosure, and serve to assist in understanding of the technical ideas of the disclosure along with the detailed descriptions of the disclosure that follows, and the disclosure should not be construed as limited to the matters shown in the drawings.

FIG. 1 is a view illustrating a configuration of a point cloud compression system for streaming according to an embodiment;

FIG. 2 is a view illustrating an example of a process of a point structuring device of FIG. 1;

FIG. 3 is a view illustrating a detailed configuration of a point normal vector estimation device of FIG. 2;

FIG. 4 is a view illustrating an example of a point arrangement process of a temporary memory of FIG. 3;

FIG. 5 is a view illustrating an operating process of a point arrangement unit of FIG. 3;

FIG. 6 is a view illustrating an example of an arrangement of points in the temporary memory of FIG. 5;

FIG. 7 is a view illustrating a concept of a normal vector of a normal vector derivation unit of FIG. 3;

FIG. 8 is a view illustrating an operating process of the normal vector derivation unit of FIG. 3;

FIG. 9 is a view illustrating an operating process of a normal vector optimization unit of FIG. 4;

FIG. 10 is a view illustrating a normal vector of each point that is optimized based on FIG. 9; and

FIG. 11 is a view provided to explain a concept of extracting points for encoding according to an embodiment.

### BEST MODE

Hereinafter, embodiments of the disclosure will be described in more detail with reference to the drawings.

The advantages and features of the disclosure, and methods for achieving them will become apparent by referring to the embodiments described herein with reference to the accompanying drawings. However, the disclosure is not limited to the embodiments disclosed herein, but may be embodied in many different forms, and the embodiments are provided merely to make the disclosure complete and to fully inform those skilled in the art of the scope of the disclosure, and the disclosure is defined by the scope of the claims.

The terms used in the specification will briefly be described first, and the disclosure will be described in detail.

The terms used in the disclosure are chosen to be general terms currently used considering the functions mentioned in the disclosure, but may vary depending on the intent of those skilled in the art or precedent, the emergence of new technologies, etc. In addition, in specific cases, the terms may be chosen arbitrarily by the applicant, and in this case, their meanings will be explained in detail in the descriptions of the invention. Accordingly, the terms used in the disclosure should not be defined solely based on their names and should be defined based on the meaning of the terms and the whole context of the disclosure.

It will be further understood that when a certain portion is referred to as “including” a certain element, it means that the certain portion does not exclude other components and may further include other components unless the context clearly indicates otherwise.

Accordingly, the functions provided within components and “units” may be combined into fewer components and “units” or further separated into additional components and “units”.

Hereinbelow, embodiments of the disclosure will be described in detail with reference to the accompanying drawings, so that they are easily embodied by those skilled in the art. In order to clearly illustrate the disclosure in the drawings, parts having nothing to do with the descriptions are omitted.

An embodiment may include a certain number of each of the components as a certain appropriate configuration. In general, computer and communication systems are shown as configurations of a wide range, and the drawings do not limit the scope of the disclosure to a certain specific configuration. The drawings illustrate one operating environment in which the various features disclosed herein may be used, but such features may be used in any other suitable system.

In explaining the specification, an entity that performs operations may be a processor that converts each point of a spherical point cloud into a point of a hexahedron and then structures points in the form of a tree, sets each point of the tree structure as a reference point, and then derives a normal vector of each point through an adjacent point search and normal vector estimation algorithm, based on a predefined reference distance and a computational distance between the set corresponding reference point and each point of a child node which is a subordinate node of a node of the corresponding reference point, and as another example, may be a recording medium on which a program performing estimation and processing is recorded, or an apparatus including the same.

The adjacent point search and normal vector estimation algorithm may be performed sequentially with respect to all points of the tree structure based on the tree structure, and here, the corresponding reference point refers to a point that is set as a reference point among the points of the tree structure.

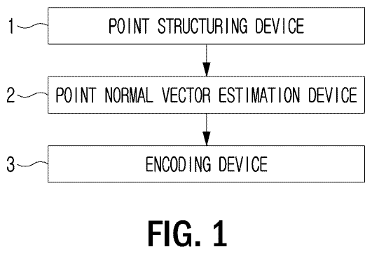

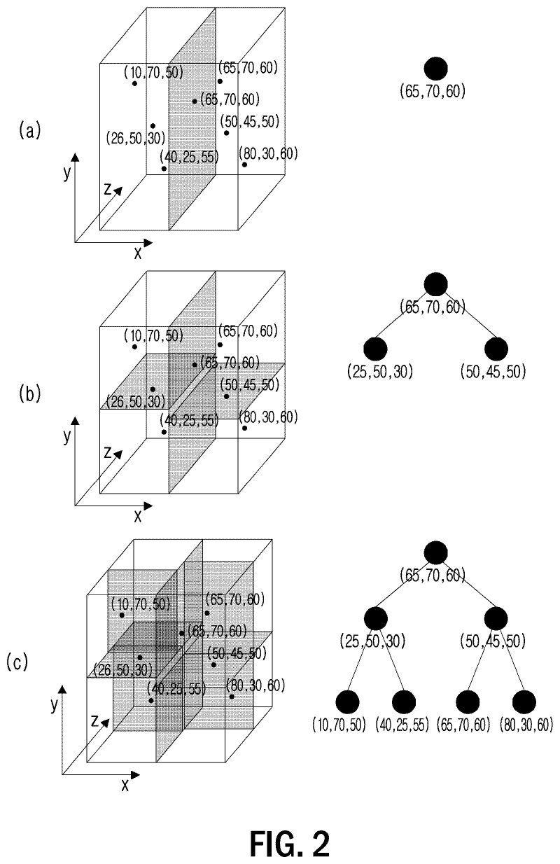

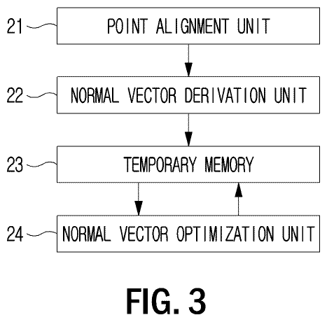

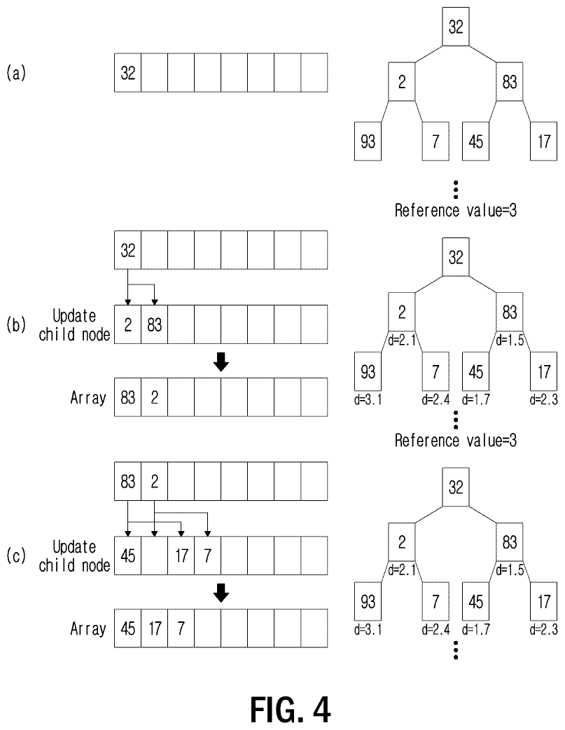

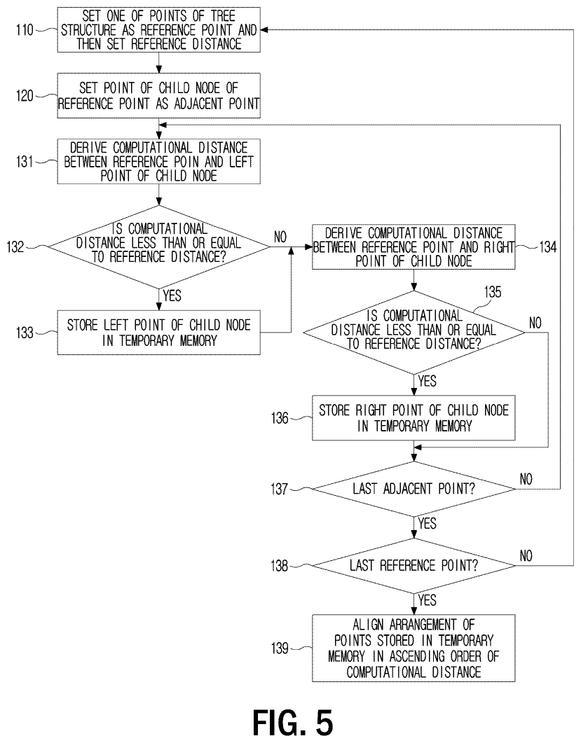

FIG. 1 is a view illustrating a configuration of a point cloud compression system for streaming according to an embodiment, FIG. 2 is a view provided to explain a point structuring process of FIG. 1, FIG. 3 is a conceptual view of a normal vector of points, FIG. 4 is a view illustrating a detailed configuration of a point normal vector estimation device of FIG. 1, and FIG. 5 is a view illustrating an example of an arrangement of points in a temporary memory of FIG. 4.

Referring to FIGS. 1 to 5, the point cloud compression system for streaming according to an embodiment may have a configuration that converts each point of a spherical point cloud into a point of a hexahedron and then structures points in the form of a tree, derives a normal vector for points where a computational distance between a reference point of the established three structure and each point of a child node which is a subordinate node of the reference point is less than or equal to a reference distance, and performs encoding with respects to points that are extracted based on an inner product value of the derived normal vector and a direction vector of user's field of view acquired through a camera, and the system may include a point structuring device 1, a point normal vector estimation device 2, and an encoding device 3.

The point structuring device 1 performs a function of mapping each point of the point cloud onto a cube-shaped hexahedron and then structuring each point of the mapped hexahedron in the form of a tree.

In an embodiment, the process of mapping each point of a spherical point cloud onto each surface of a cube-shaped hexahedron is not specifically described but this will be understood by those skilled in the art.

The point structuring device 1 structures each point of the hexahedron in the form of a tree. For example, referring to FIG. 2, the point structuring device 1 may construct a first node with a point (60, 70, 60) positioned at the center of the X-axis of the hexahedron as shown in view (a), and then, may construct second nodes (hereinafter, referred to as child nodes) as subordinate nodes of the first node with points (25, 50, 30), (50, 45, 50) positioned at the center of the Y-axis of each of the two areas divided by the X-axis of the hexahedron as shown in view (b), and may construct child nodes as subordinate nodes of the second nodes with points (10, 70, 50), (40, 25, 55), (65, 70, 60), (80, 30, 60) positioned at the center of the Z-axis of each of the four areas divided by the X-axis and the Y-axis of the hexahedron as shown in view (c). The process of structuring the cube-shaped points into a tree structure is repeatedly performed for all points of the spherical point cloud. Here, the point (25, 50, 30) indicates a point position of the X, Y, Z-axis coordinate systems of points.

Each point of the tree structure is delivered to the point normal vector estimation device 2.

The point normal vector estimation device 2 has a configuration that sequentially sets a reference point from the points of the tree structure, searches for adjacent points based on a computational distance d which is a distance difference from the set corresponding reference point, and derives a normal vector of the reference point that is perpendicular to a plane formed by the two searched adjacent points and the reference point.

Referring to FIG. 3, the point normal vector estimation device 2 may include a point alignment unit 21, a normal vector derivation unit 22, a temporary memory 23, and a normal vector optimization unit 24.

Herein, the point alignment unit 21 may search for points where a computational distance between a reference point sequentially set from a point of each node of the point structuring device 1 and a point of a child node of the reference point is less than or equal to a defined reference distance, may store the searched points in the temporary memory 23, and then aligns the points stored in the temporary memory 23 in ascending order of the computational distance.

For example, referring to FIG. 4, when the corresponding reference point is set to the point of the first node, the point alignment unit 21 may calculate a distance between a point of a child node which is a subordinate node of the first node and the corresponding reference point, and generates a point arrangement with points in which the computational distance d is less than or equal to the defined reference distance.

Specifically, when a point of point index 32 is set as the corresponding reference point as shown in view (a) of FIG. 4, a computational distance d may be derived by calculating a distance difference between point indexes 2 and 83 of child nodes which are subordinate nodes of point 32, and the set corresponding reference point 32 as shown in view (b), and in this case, the derived computational distance d is 2.1 and 1.5, respectively, which are less than or equal to the reference distance r=3, and hence, the points of point indexes 2 and 83 are stored in the temporary memory 23.

Meanwhile, as shown in view (c) of FIG. 4, the point alignment unit 21 may calculate a distance between the corresponding reference point of point index 2 and each point of point indexes 93, 7 of child nodes of the reference point, and in this case, the computational distance d is 3.1 and 2.4, respectively.

In addition, the point alignment unit 21 may calculate a distance between the corresponding reference point of point index 83 and each point of child nodes of the reference point, and in this case, the computational distances d is 1.7, 2.3 respectively. Accordingly, point indexes 45, 17, 7 which are less than or equal to the reference distance (r=3) are stored in the temporary memory 23. Such an arrangement of points in the temporary memory 23 is performed for each point of all nodes.

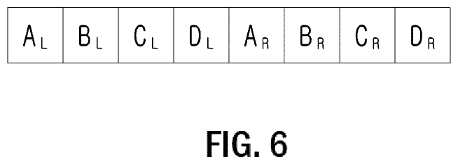

FIG. 5 is a view provided to explain operations of the point arrangement unit 21 of FIG. 3, and FIG. 6 is a view illustrating an example of an arrangement of points in the temporary memory 23 of FIG. 3, and referring to FIGS. 5 and 6, the point arrangement unit 21 arranges points in the temporary memory based on a distance between a reference node sequentially set from each point of the tree structure and each point of a child node which is a subordinate node of the node that the reference node belongs to.

Referring to FIG. 5, at steps 110 and 120, the point arrangement unit 21 sets an arrangement of points of the temporary memory that is formed with a pre-defined number of points of a point cloud, and a reference distance r, and inserts a point of each node to the set arrangement of points of the temporary memory.

The reference distance r in the specification is a result value obtained through a plurality of experiments, and may be set, reflecting a resolution of a reproduced content.

At steps 131 to 133, the point arrangement unit 21 inserts a left point AL to the arrangement of points of the temporary memory, based on the set reference distance and a computational distance between the set reference point of the tree structure and the left point A_{L} among child nodes which are subordinate nodes of a node that the reference point belongs to.

That is, when the computational distance is less than or equal to the reference distance (proceeding in the arrow direction of “Yes” o), the point arrangement unit 21 inserts the left point to the left position of the temporary memory.

When the computational distance is not less than or equal to the reference distance at step 132 (proceeding in the arrow direction of “No”), the point normal vector estimation device 2 inserts a right point to the arrangement of points of the temporary memory, based on the set reference distance and a computational distance between the reference point and the right point AR which is a child node of the first node at steps 134 to 136.

That is, when the computational distance is less than or equal to the reference distance (proceeding in the arrow direction of “Yes”), the point arrangement unit 21 inserts the right point A_{R} to the right position of the temporary memory.

At steps 137 to 139, the point arrangement unit 21 determines whether the last of adjacent points or the last node of the point tree structure is reached, and, when the last node is reached (proceeding in the arrow direction of “Yes”), aligns the points stored in the temporary memory in ascending order of the computational distance with the reference point.

The point arrangement unit 21 repeatedly proceeds to step 131 when the point alignment unit 21 proceeds in the arrow direction of “No” at step 137. Accordingly, the arrangement of points in the temporary memory is stored in the order of points A_{L}, B_{L}, C_{L}, D_{L}, D_{R}, C_{R}, B_{R}, A_{R} as shown in FIG. 6.

Thereafter, the point alignment unit 21 aligns the arrangement of points in the temporary memory 23 in order of the computational distance at step 138, and accordingly, the arrangement of points in the temporary memory 23 is aligned in ascending order of the computational distance, such that the temporary memory 23 stores the points in the order of points having a short computational distance from the reference point.

Accordingly, in an embodiment, the number of points stored in the temporary memory 23, which are the points whose computational distance is less than or equal to the reference distance, may be reduced compared to the number of input points. Accordingly, computational complexity of the normal vector for each point described below is reduced.

The normal vector derivation unit 22 of FIG. 3 derives a normal vector as a perpendicular vector to a plane which consists of two adjacent points which are searched as a first point and a second point of the temporary memory 23, and one reference point.

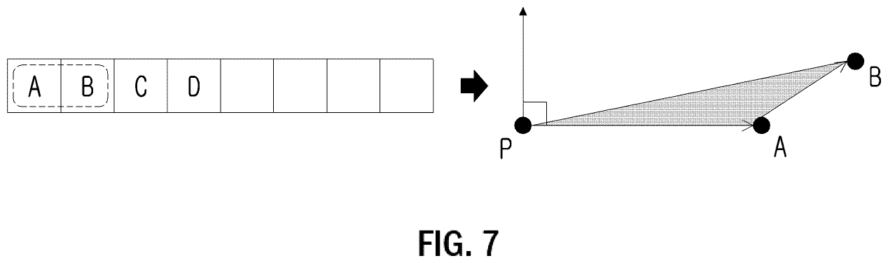

FIG. 7 is a conceptual view of the normal vector of the normal vector derivation unit of FIG. 3. Referring to FIG. 7, the normal vector is a perpendicular vector to a plane that is formed with a certain reference point A defined among the points of the temporary memory and adjacent points A′, A″.

The normal vector may be derived by a compute unified device architecture (CUDA) parallel processing algorithm, and accordingly, the normal vector derivation unit 22 sets a CUDA threshold value of a CUDA kernel function for each point and derives the normal vector with the set CUDA threshold value, two adjacent points and one reference point.

In an embodiment, the process of deriving the normal vector through the compute unified device architecture (CUDA) parallel processing algorithm with the set CUDA threshold value, the two adjacent points and the one reference point as input is not specifically described in the specification, but may be understood by those skilled in the art.

The derived normal vector for each point is provided to the temporary memory 23, and accordingly, each point less than or equal to the reference distance that is stored in the temporary memory 23 may include information such as a point index, point position coordinates of the hexahedron, and the derived normal vector.

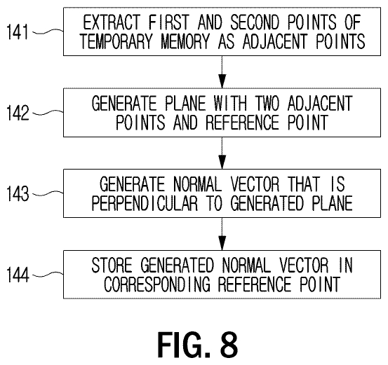

FIG. 8 is a view illustrating an operating process of the normal vector derivation unit of FIG. 4. Referring to FIG. 8, at steps 141 to 144, the normal vector derivation unit 22 extracts the first point and the second point of the temporary memory as adjacent points, generates a plane based on the extracted two adjacent points and the reference point, and then derives a normal vector that is perpendicular to the generated plane, and inserts the derived normal vector into the corresponding reference point of the temporary memory 23. Here, the first point and the second point of the temporary memory 23 are adjacent points that have a short distance from the reference point. Thereafter, the normal vector derivation unit 22 proceeds to step 138.

In the point cloud compression system for streaming, the normal vector derived by using perpendicularity to the plane is accurate for a plane part of an object in a produced content, but the accuracy is degraded in a curved part. Therefore, the point normal vector estimation device 2 derives an average value of the normal vectors of at least three points of the temporary memory and then sets the derived average normal vector as a normal vector of the corresponding reference point. Accordingly, all points stored in the temporary memory 23 are normalized.

Meanwhile, the normal vector optimization unit 24 of FIG. 3 extracts at least three adjacent points with respect to a corresponding point of the temporary memory 23, averages the normal vectors of the extracted adjacent points, and sets the average normal vector as a normal vector of the corresponding reference point.

Accordingly, in an embodiment, the points whose computational distance with the reference point is less than or equal to the pre-defined reference distance are aligned in ascending order of the computational distance and are stored in the temporary memory, so that it is easy to search for adjacent points and the number of times of searching for adjacent points may be reduced.

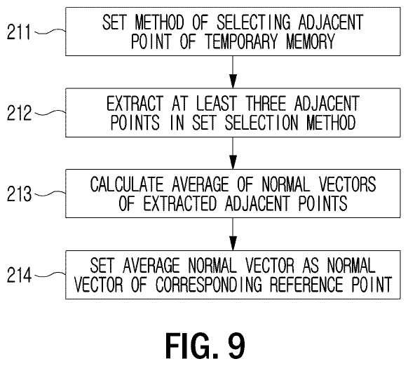

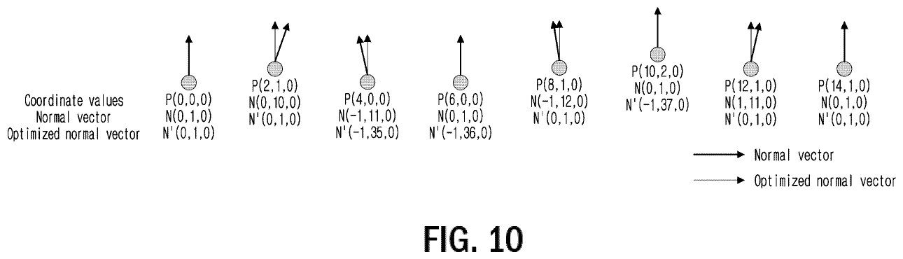

FIG. 9 is a view illustrating an operating process of the normal vector optimization unit of FIG. 4, and FIG. 10 is a view illustrating comparison of an optimized normal vector and the normal vector of FIG. 8. Referring to FIGS. 9 and 10, at steps 211 to 212, the normal vector optimization unit 24 according to an embodiment sets a method of selecting adjacent points stored in the temporary memory, and extracts adjacent points in the temporary memory according to the set adjacent point selection method. For example, when the adjacent point selection method is a first N point extraction method, the first point to the N-th point are extracted as adjacent points. In another example, when the adjacent point selection method is a method of extracting points within a predefined computational distance, points within the predefined computational distance from a corresponding point are extracted as adjacent points.

At steps 213, 214, the normal vector optimization unit 24 calculates an average of normal vectors of the extracted points, and sets the calculated average normal vector as a normal vector of the corresponding reference point and stores the same in the temporary memory, and then proceeds to step 138 after executing step 214.

Referring to FIG. 10, it can be seen that the normal vector optimized by the normal vector optimization unit 24 is an optimized normal vector compared to the normal vector derived based on FIG. 8.

Furthermore, the encoding device 3 of FIG. 1 compresses points of an object position that match the user's field of view acquired through a camera (not shown) by using the derived normal vector, and transmits the points.

When an inner product value derived by obtaining an inner product of a direction vector of a camera and a normal vector of points of an object of a content is positive, the encoding device 3 encodes the corresponding point, and, when the inner product value is negative, the encoding device 3 determines that the point is out of the user's field of view.

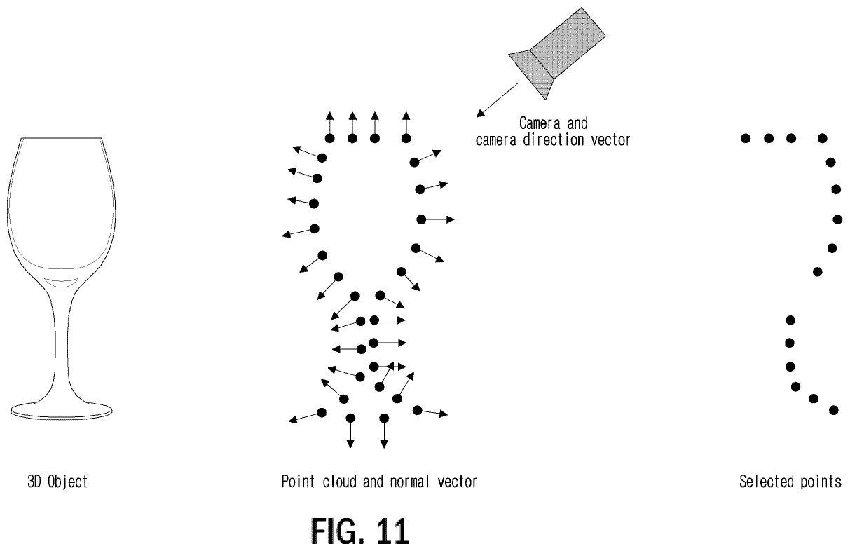

FIG. 11 is a view illustrating an example of points which are encoded for an object in a produced content. As shown in FIG. 10, it can be seen that corresponding points existing within the user's field of view that are obtained by the camera (not shown) are encoded.

Accordingly, in an embodiment, in a point cloud of an object in a produced content, a normal vector of points whose computational distance from a reference point in a tree structure is less than or equal to a reference distance is generated, so that computational complexity of the normal vector may be reduced, and accordingly, encoding speed may be enhanced, and versatility may be enhanced since it is applicable to lightweight devices.

Although the above embodiments have been described based on limited examples and drawings, it is obvious that various modifications and changes may be made by those skilled in the art from the above descriptions. For example, appropriate results may be achieved even when the described techniques are performed in a different order from that described above, and/or components such as the described systems, structures, devices, circuits, etc. are coupled or combined in a different form from that described above, or substituted or replaced by other components or equivalents. Accordingly, the scope of the disclosure should not be limited to the described embodiments, but should be defined by the following claims as well as by the equivalents of the claims.

1. A point cloud compression system for streaming, the point cloud compression system comprising:
a point structuring device configured to convert a spherical point cloud of a produced content into points of a hexahedron, and then to convert the points into points in a tree structure;
a point normal vector estimation device configured to set a point of each node of the tree structure sequentially as a reference point, and to derive a normal vector of each point based on a defined reference distance and a computational distance between each of the set reference points and each point of a child node which is a subordinate node of a node comprising each reference point; and
an encoding device configured to extract points based on an inner product value of the normal vector of each point and a direction vector of a user's field of view acquired by a camera, and to encode and transmit the extracted points.

2. The point cloud compression system of claim 1, wherein the point normal vector estimation device comprises:
a point alignment unit configured to set a point of each node of the tree structure sequentially as a reference point, to output a computational distance between the corresponding reference point and a point of a child node, to store points where the outputted computational distance is less than or equal to a pre-defined reference distance in a temporary memory, and to align the points stored in the temporary memory in an ascending order of the computational distance; and
a normal vector derivation unit configured to derive a normal vector of the reference point in a direction perpendicular to a plane that is formed with adjacent points obtained as a first point and a second point of the temporary memory for the corresponding reference point, and the corresponding reference point, and to store the normal vector in the corresponding reference point of the temporary memory.

3. The point cloud compression system of claim 2, wherein the point normal vector estimation device further comprises a normal vector optimization unit configured to extract at least three points as adjacent points of the corresponding reference point, to average the normal vectors of the extracted points, and then to set the average normal vector as a normal vector of the corresponding reference point.

4. The point cloud compression system of claim 3, wherein the encoding device is configured to derive an inner product value of the direction vector of the user's field of view acquired through the camera and the normal vector of each point, and to encode and transmit a point where the derived inner product value is positive.

5. A point normal vector estimation device of the point cloud compression system for streaming of claim 1, the point normal vector estimation device comprising:
a point alignment unit configured to convert points of a hexahedron of a produced content into a tree structure, to set a point of the converted tree structure sequentially as a reference point, to store points where a computational distance between the set corresponding reference point and each point of a child node of a node comprising the corresponding reference point is less than or equal to a pre-defined reference distance in a temporary memory, and to align the points stored in the temporary memory in an ascending order of the computational distance; and
a normal vector derivation unit configured to derive a normal vector in a direction perpendicular to a plane that is formed with two adjacent points of the temporary memory and the corresponding reference point, and to store the derived normal vector in the corresponding reference point of the temporary memory.

6. The point normal vector estimation device of the point cloud compression system for streaming of claim 5, further comprising a normal vector optimization unit configured to extract at least three points as adjacent points of the corresponding reference point, to average the normal vectors of the extracted points, and then to set the average normal vector as a normal vector of the corresponding reference point.

7. A point cloud compression method for streaming, which is performed based on the point cloud compression system for streaming of claim 1, the point cloud compression method comprising:
a point structuring step of converting a spherical point cloud of a produced content into points of a hexahedron, and then converting the points into points in a tree structure;
a point normal vector estimation step of setting each point of the tree structure as a reference point, and deriving a normal vector of each point based on a defined reference distance and a computational distance between the set corresponding reference point and each point of a child node which is a subordinate node of a node of the corresponding reference point; and
an encoding step of extracting points based on an inner product value of the normal vector of each point and a direction vector of a user's field of view acquired by a camera, and encoding and transmitting the extracted points.

8. The point cloud compression method of claim 7, wherein the point normal vector estimation step comprises:
a step of setting each point of the tree structure as a reference point, and outputting a computational distance between the set corresponding reference point and each point of the child node;
a step of storing points where the outputted computational distance is less than or equal to a pre-defined reference distance in a temporary memory, and aligning the points stored in the temporary memory in an ascending order of the computational distance; and
a step of deriving a normal vector of the corresponding reference point in a direction perpendicular to a plane that is formed with adjacent points obtained as a first point and a second point of the temporary memory for the corresponding reference point, and the corresponding reference point, and storing the derived normal vector of the corresponding reference point in the corresponding reference point of the temporary memory.

9. The point cloud compression method of claim 8, wherein the point normal vector estimation step further comprises a step of extracting at least three points as adjacent points of the corresponding reference point, averaging the normal vectors of the extracted at least three points, and then setting the average normal vector as a normal vector of the corresponding reference point.

10. The point cloud compression method of claim 9, wherein the encoding step is provided to derive an inner product value of the direction vector of the user's field of view acquired through the camera and the normal vector of each point, and to encode and transmit a point where the derived inner product value is positive.

11. A non-transitory computer-readable recording medium on which the point cloud compression method for streaming of claim 7 is recorded and which is performed by a computer.
